(19) United States
(12) Patent Application Publication
(10) Pub. No.: US 2005/0182640 A1
(43) Pub. Date: Aug. 18, 2005

(54) Safety-related information delivering method, delivering apparatus, and delivering system

(75) Inventors: Kosei Takano, Tokyo (JP); Takashi Tsuchida, Yokohama (JP); Akio Fujino, Tokyo (JP); Hiroshi Inagawa, Tokyo (JP); Tomohisa Misawa, Kawasaki (JP); Daiji Yamano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/895,923

(22) Filed: Jul. 22, 2004

(30) Foreign Application Priority Data
Feb. 16, 2004 (JP) 2004-038052

(51) Int. Cl. G06F 17/60

(52) U.S. Cl. 705/1

(57) ABSTRACT

A safety-related information delivering apparatus comprises a unit determining whether a person who desires the delivery of safety-related information desires schedule-delivery of information according to his or her schedule or the zone-delivery of information according to his or her current location, and a unit delivering the safety-related information in correspondence with a determination result.

### BACKGROUND OF THE INVENTION

1. Field of the Invention

The present invention relates to a safety-related information delivering method, delivering apparatus, and delivering system, which make, for example, a subscriber of an overseas travel accident insurance conduct preliminary learning for safety-related information, and deliver safety-related information corresponding to a travel destination to a traveler staying at the travel destination via a network.

2. Description of the Related Art

A system making a user conduct predetermined learning, and offering some bonus to the user according to a score based on the learning is used, for example, in an insurance industry, etc. The following documents disclose such a conventional technique.

[Patent Document 1] Japanese Patent Publication No. 2001-325347 “Learning User Targeting Processing Apparatus, Learning User Targeting Processing Method, and Storage Medium”

[Patent Document 2] Japanese Patent Publication No. 2002-117236 “Insurance Fee Setting Method, Insurance Fee Setting System, and Storage Medium Recording an Insurance Fee Setting Program”

[Patent Document 3] Japanese Patent Publication No. 2003-99505 “Travel Information Collecting System, Travel Information Collecting Method, and Travel Information Collecting Program”

Patent Document 1 discloses a learning user targeting processing apparatus, etc., which execute a process for making, for example, a contractor of a car insurance conduct learning for avoiding a risk, and for offering a bonus such as a discount of an insurance fee, etc. to the contractor according to the efforts of the learning.

Patent Document 2 discloses an insurance fee setting method making, for example, an insured person of a life insurance conduct learning by presenting information about risks covered by the insurance, and reflecting the efforts (such as the amount of time, the degree, the number of times, etc.) of the learning on an insurance fee.

Patent Document 3 discloses a travel information collecting system for offering to a traveler up-to-date and detailed local travel information such as sightseeing spots, sightseeing facilities, lodgings, restaurants, etc. This system also enables the traveler to obtain new separate information at a travel destination.

The above described methods are also applied to an overseas travel accident insurance in a similar manner, and a traveler is made to conduct preliminary learning, whereby advantages such that an insurance fee can be made inexpensive to the traveler, and the number of trouble cases decreases as a result in an insurance company are expected.

However, even if such a service exists, it is difficult for a traveler to commit sufficient time for learning prior to the departure for a travel, and the traveler sometimes departs for the travel without conducting learning, or the traveler can possibly forget about contents of learning if he or she conducts the preliminary learning. Additionally, a traveler's attention is frequently diverted to other things at a travel destination, and it is difficult for the traveler to search for trouble information by himself.

Furthermore, even if up-to-date information about an accident, a crime, etc. is delivered at a travel destination, its contents are not related to an insured person in some cases, for example, when the information is delivered regardless of individual attributes such as sex, travel purpose, age, etc. In such a case, a traveler, etc. must determine which information item is important to him or her, leading to a lot of troublesomeness to the traveler, etc.

### SUMMARY OF THE INVENTION

An object of the present invention is to improve the safety of a traveler, a person who makes a business trip, a person who stays overseas, etc. by making the traveler, etc. conduct preliminary learning, by way of example, for safety, and by delivering, for example, yet-to-be-learned safety-related information, new related trouble information, or the like according to the attributes and the learning history of an individual, and the degree of importance of information, etc. during the travel, in view of the above described problems.

A safety-related information delivering method according to the present invention is a method with which a computer delivers safety-related information to a person who desires the delivery of the safety-related information. With this method, the computer determines according to contents stored in a memory whether the person who desires the delivery desires either schedule-delivery which is delivery of safety-related information according to his or her schedule or zone-delivery which is delivery of safety-related information corresponding to the current location of the person, and delivers the safety-related information to the person in correspondence with a determination result via a network.

### BRIEF DESCRIPTION OF THE DRAWINGS

FIG. 1 is a block diagram showing the principle of the configuration of a safety-related information delivering apparatus according to the present invention;

FIG. 2 is a block diagram showing the whole of the configuration of a safety-related information delivering system according to the present invention;

FIG. 3 is a block diagram showing the details of the configuration of a traveler learning assisting center shown in FIG. 2;

FIG. 4 exemplifies contents stored in an individual attribute database;

FIG. 5 exemplifies contents stored in a travel history database;

FIG. 6 exemplifies contents stored in a travel schedule database;

FIG. 7 exemplifies contents stored in a learning contents database;

FIG. 8 exemplifies contents stored in an individual learning menu database;

FIG. 9 exemplifies contents stored in a learning history database;

FIG. 10 exemplifies contents stored in an up-to-date information database;

FIG. 11 is a flowchart showing a process for registering a travel schedule, and for creating an individual learning menu;

FIG. 12 is a flowchart showing a process for preliminary learning;

FIG. 13 is a flowchart showing a process for collecting up-to-date information;

FIG. 14 is a flowchart showing a process for delivering travel destination information;

FIG. 15 is a flowchart showing the details of a process for schedule-delivery;

FIG. 16 exemplifies contents stored in a delivery setting table;

FIG. 17 is a flowchart showing the details of a process for zone-delivery; and

FIG. 18 explains a screen display transition made on a traveler terminal.

### DESCRIPTION OF THE PREFERRED EMBODIMENTS

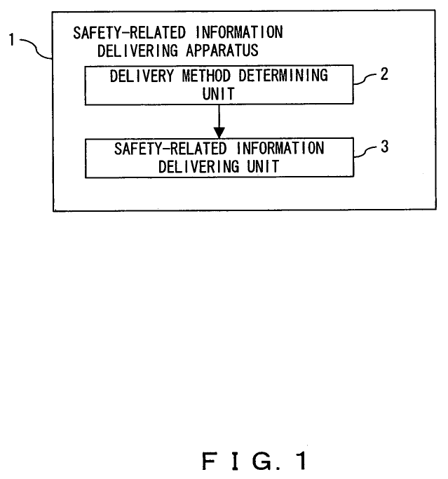

FIG. 1 is a block diagram showing the principle of the configuration of a safety-related information delivering apparatus according to the present invention. This figure shows the principle of the configuration of the apparatus delivering safety-related information, such as crime information and accident information to a person who desires delivery, for example, an overseas traveler, a person who makes an overseas business trip, a person who stays overseas, etc. The safety-related information delivering apparatus 1 comprises at least a delivery method determining unit 2 corresponding, for example, to a local delivering unit, and a safety-related information delivering unit 3.

The delivery method determining unit 2 determines whether a person who desires the delivery of safety-related information desires either schedule-delivery which is delivery of the safety-related information according to his or her schedule or zone-delivery which is delivery of safety-related information corresponding to the current location of the person. The safety-related information delivering unit 3 delivers the safety-related information to the person who desires the delivery in correspondence with a determination result.

As a safety-related information delivering method according to the present invention, a method with which a computer determines whether a person who desires the delivery of safety-related information desires either schedule-delivery according to his or her schedule or the zone-delivery of safety-related information corresponding to the current location of the person, and delivers the safety-related information to the person in correspondence with a determination result via a network is used.

In a preferred embodiment according to the present invention, up-to-date information can be received externally, for example, from an overseas travel agent, etc. as safety-related information, and can be stored in a memory by being assigned the degree of importance. Or, information stored in the memory can be selected and delivered when the safety-related information is delivered. Or, the degree of importance assigned to the up-to-date information stored in the memory can be changed in correspondence with a condition including the current location of a person who desires the delivery, and the up-to-date information to which a high degree of importance after being changed is assigned can be delivered.

Additionally, the person who desires the delivery can be made to conduct preliminary learning for improving safety, and a learning history corresponding to the results of the learning can be stored in the memory. Or, in correspondence with the individual attributes, the history of staying at location, the schedule and the learning history of the person, an individual learning course for the preliminary learning can be created, and the person can be made to conduct the preliminary learning with the individual learning course. Or, new learning contents corresponding to the current location of the person can be delivered to the person in correspondence with the learning history stored in the memory when the safety-related information is delivered.

Furthermore, in the preferred embodiment, the above described up-to-date information can be selected and delivered in correspondence with the individual attributes of the person who desires the delivery, or the history of staying at location when the safety-related information is delivered. Or, a schedule change from the person who desires the above described schedule delivery can be accepted, and the safety-related information can be delivered with the reflection of the contents of the change.

Still further, in the preferred embodiment, the above described up-to-date information can be stored in the memory, and important safety information can be delivered at a preset time regardless of whether the person who desires the delivery desires either the above described schedule-delivery or zone-delivery.

A safety-related information delivering system according to the present invention is configured by the above described safety-related information delivering apparatus 1 comprising the delivery method determining unit 2 and the safety-related information delivering unit 3, and a terminal device comprising a display unit displaying safety-related information delivered by the safety-related information delivering unit 3 within the apparatus 1.

As described above, according to the present invention, safety-related information is delivered in correspondence with a result of determining whether, for example, an overseas traveler desires either the delivery according to his or her schedule or the delivery corresponding to his or her current location.

According to the present invention, for example, a contractor of an overseas travel accident insurance can be made to conduct preliminary learning about safety, and up-to-date safety-related information can be delivered, for example, in correspondence with the individual attributes, the learning history, etc. of the traveler, or according to the degree of importance of the information during a travel, whereby the safety of the traveler, etc. can be improved, and, for example, an insurance payment can be reduced in an insurance company.

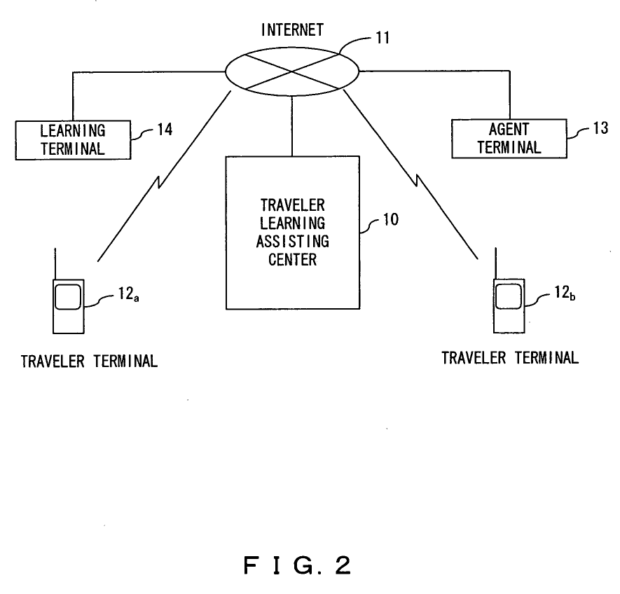

FIG. 2 is a block diagram showing the whole of the configuration of the safety-related information delivering system according to the present invention. In this figure, the system is configured by: a traveler learning assisting center 10 making, for example, a traveler conduct preliminary learning corresponding to a travel destination, and delivering safety-related information to the traveler during a travel; traveler terminals 12a and 12b, which are connected to the traveler learning assisting center 10 via the Internet 11; an agent terminal 13 for collecting up-to-date safety information, for example, at a travel destination; and a learning terminal 14 (for example, installed in a local agent shop) with which the traveler conducts further learning on demand.

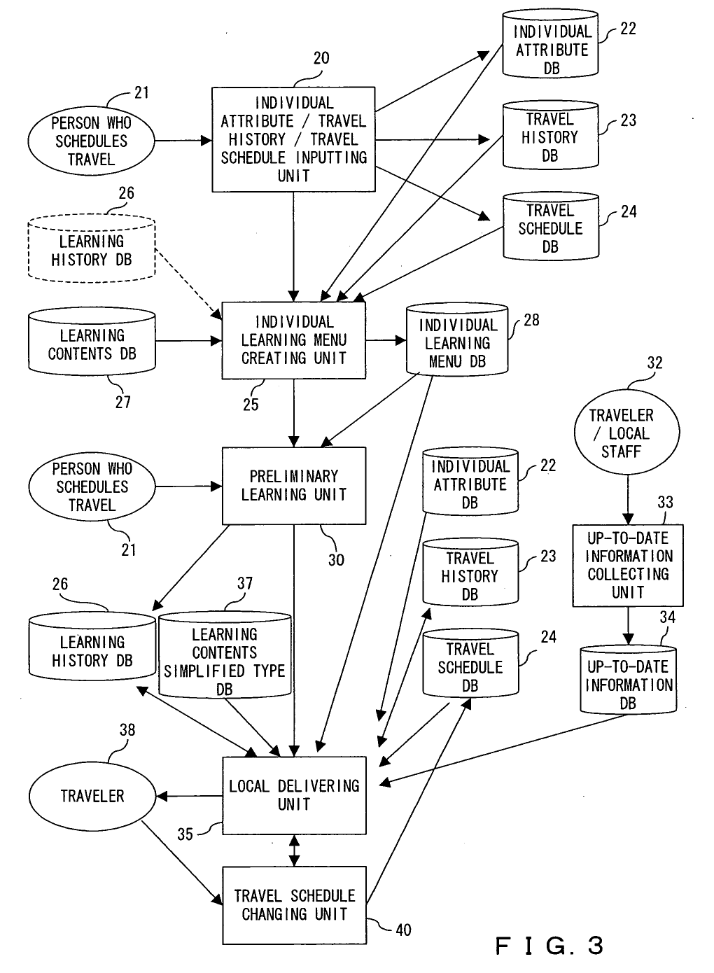

FIG. 3 is a block diagram showing the details of the configuration of the traveler learning assisting center 10 shown in FIG. 2. In this figure, a necessary report is first made from a person who schedules a travel 21 to an individual attribute/travel history/travel schedule inputting unit 20, and contents of an individual attribute database 22, a travel history database 23, and a travel schedule database 24 are created. The contents of these databases will be described later.

In this preferred embodiment, learning for avoiding an accident or a crime at a travel destination, and a test for measuring the degree of understanding of the learning are conducted, for example, when an overseas travel accident insurance is subscribed prior to the departure for an overseas travel, and its results are stored as a learning history. To implement this, an individual learning menu, which is suitable for individual attributes (such as age, sex, etc.), a travel history, a travel purpose, and a schedule, is first created by an individual learning menu creating unit 25, and the created menu is stored in an individual learning menu database 28. Contents of the individual learning menu database 28 are created by being made to match also the data of the learning history database 26, for example, with the removal of already learned data if data within the learning history database 26 already exists for the person who schedules the travel 21, and by being selected from the learning contents database 27. The learning contents database 27 is assumed to fall into a normal type using, for example, a moving picture for facilitating understanding, and a simplified type mainly in a text format, by way of example, for further continuing the learning at a travel destination.

When the individual learning menu database 28 is created, the person who schedules the travel 21 is made to conduct the preliminary learning based on the menu by the preliminary learning unit 30, and its results such as a test score, etc. are stored in the learning history database 26. In the meantime, up-to-date information about local safety is collected, for example, by an overseas traveler and local staff 32, or from press coverage, police announcement, an insurance payment claim case, etc., and the collected information is stored in an up-to-date information database 34 by the up-to-date information collecting unit 33.

When the traveler 38 actually departs for the travel, safety-related information is delivered by the local delivering unit 35 during the travel. It is assumed that this safety-related information is selected from among up-to-date information 34 based on the contents of the individual attributes, the travel history, and the travel schedule, and the selected information is delivered to the traveler 38.

If the traveler 38 changes the travel schedule at the travel destination, he or she inputs contents of the change, for example, from his or her terminal. Then, the contents are received by a travel schedule changing unit 40, and the travel schedule after being changed is provided to the local delivering unit 35.

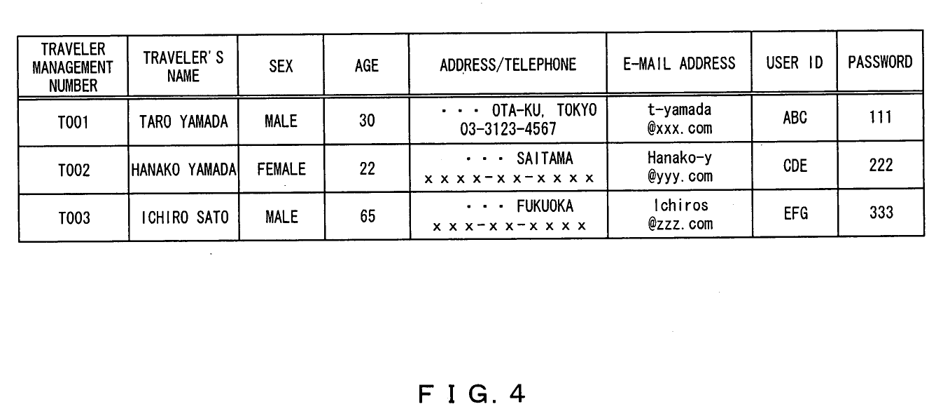

Contents stored in the databases shown in FIG. 3 are respectively described next with reference to FIGS. 4 to 10. FIG. 4 exemplifies contents stored in the individual attribute database 22. In this system, the name, the sex, the age, the address/telephone, the e-mail address, the user ID, and the password of a traveler are stored in correspondence with each traveler management number managed in a unified manner.

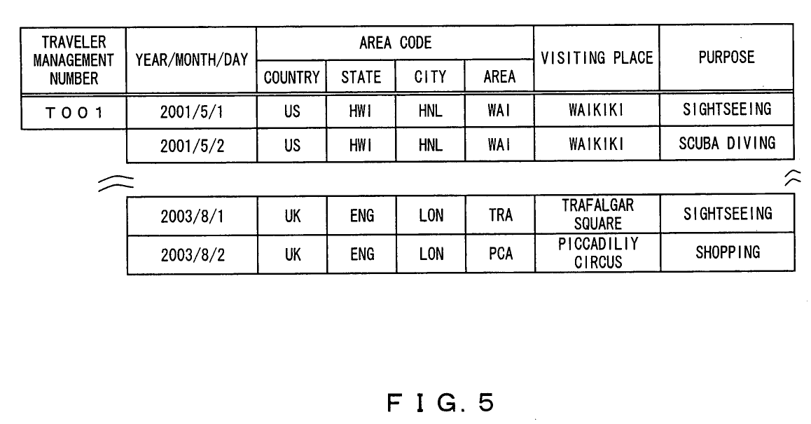

FIG. 5 exemplifies contents stored in the travel history database 23. The year, month, and day of a travel, the area code of a travel destination, a visiting place, and a purpose are stored as the travel history of a traveler corresponding to a traveler management number. As the area code, codes respectively indicating a country, a state, a city, and an area are stored. This area code is used also in the other databases. The area code in the first row indicates the U.S., Hawaii, Honolulu, and Waikiki respectively as a country, a state, a city, and an area.

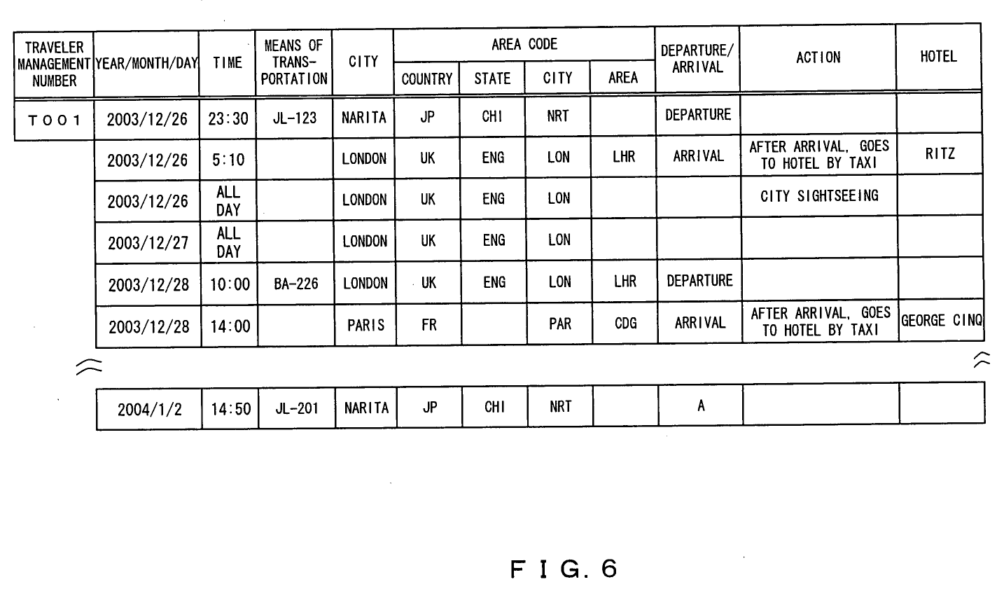

FIG. 6 exemplifies contents stored in the travel schedule database 24. As the current travel schedule of a traveler corresponding to a traveler management number, the name of a hotel to stay in addition to the year, month, and day of the schedule, time, a flight number as a means of transportation, a city, an area code, departure/arrival, and an action are stored.

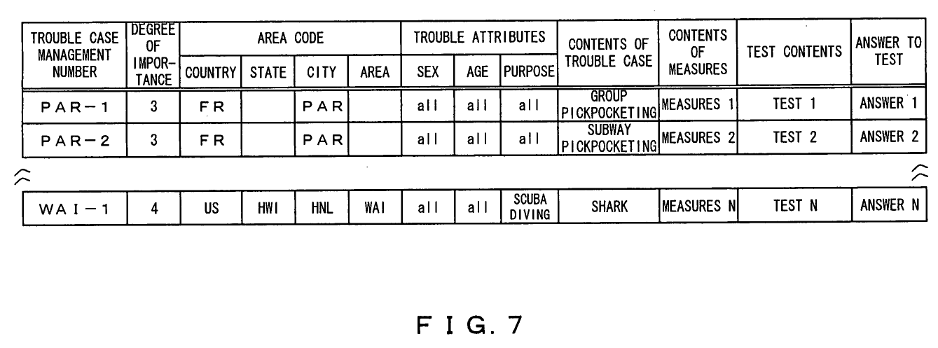

FIG. 7 exemplifies contents stored in the learning contents database 27. For each management number corresponding to a trouble case such as an accident, a crime, etc., the degree of importance of a trouble case, the area code of a place in which the trouble occurs, sex, age, and a travel purpose as individual attributes related to the trouble, contents of the trouble case such as pickpocketing, etc., contents of measures against the trouble case, contents of a test for preliminary learning, by way of example, of a person who schedules a travel, an answer to the test, and the like are stored. The degree of importance among these data items corresponds to the degree of importance of up-to-date information, which will be described later.

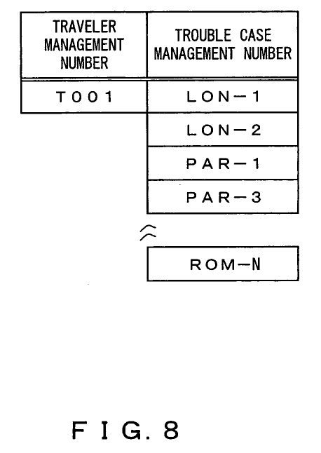

FIG. 8 exemplifies contents stored in the individual learning menu database 28. The management number of a trouble case, for which a traveler must conduct preliminary learning, is stored in correspondence with a traveler management number. Contents of a trouble case correspond to those of the learning contents database 27 shown in FIG. 7.

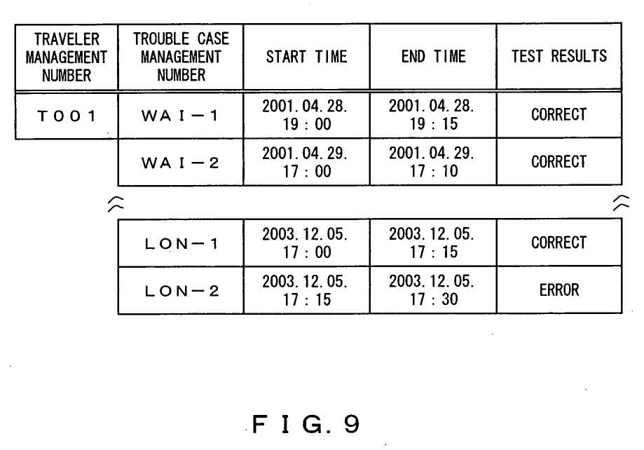

FIG. 9 exemplifies contents stored in the learning history database 26. In correspondence with a traveler management number, the start and the end times of learning, and test results are stored, by way of example, for each management number of a trouble case for which the corresponding traveler conducted preliminary learning. The test score of a person who conducted the learning can be evaluated in stages, for example, based on a correct answer ratio of test results of a plurality of trouble cases in the same area.

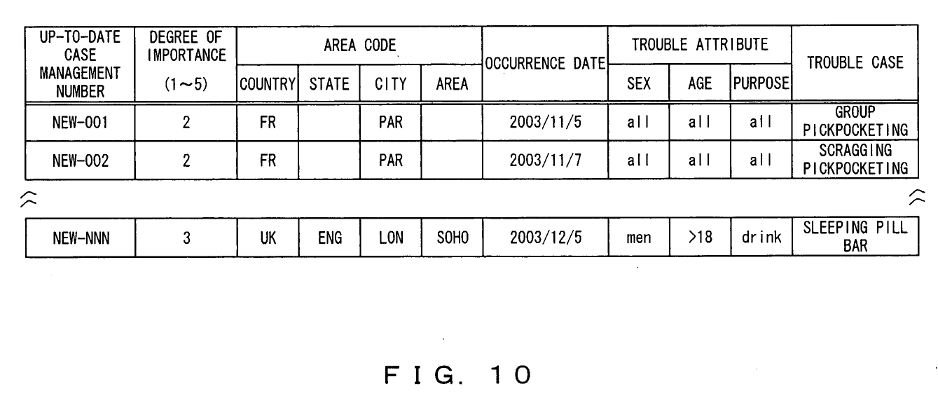

FIG. 10 exemplifies contents stored in the up-to-date information database 34. For each management number corresponding to each up-to-date case, the degree of importance, the area code of an area where an accident or a crime occurred, an occurrence date, individual attributes related to the trouble, and the trouble case are stored. The degree of importance ranges, for example, from 1 to 5. A higher level degree of importance indicates a higher risk. For example, a level 4 of the degree of importance indicates information about a hurricane or a wildfire, and a level 5 indicates the most important information such as a war, coup d'etat, an earthquake, etc. For example, in a trouble case of a sleeping pill bar, a person placing a sleeping pill in a drink while the person is in a bar and steals the said person's wallet, as an up-to-date case displayed in the bottom row, the sex, the age, and the purpose of the individual attributes as trouble attributes respectively indicate male, 18 or older, and to drink.

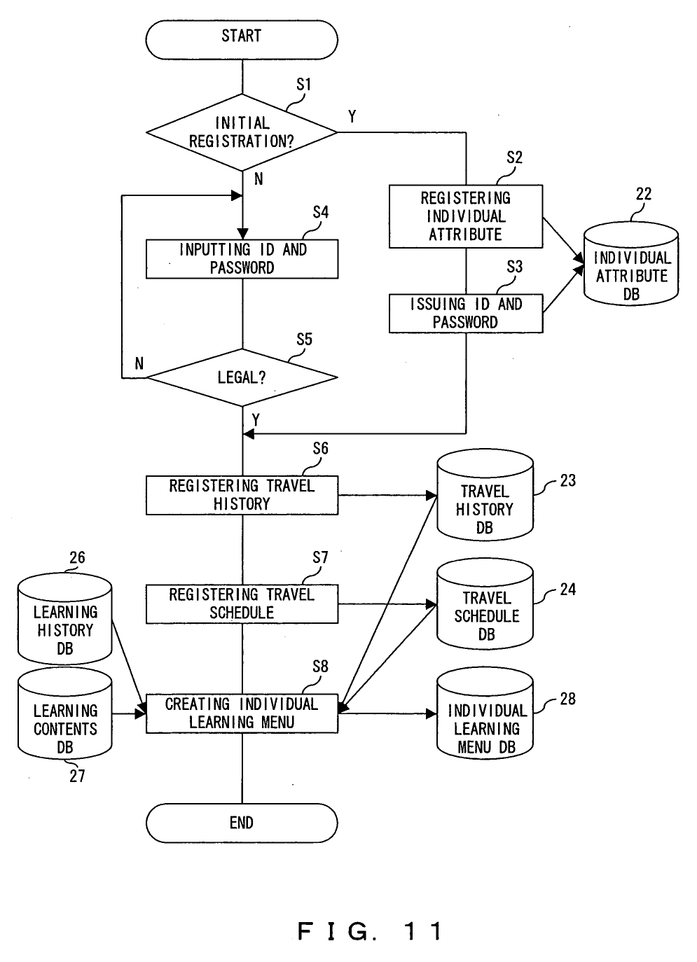

Processes executed in this preferred embodiment are described next with reference to FIGS. 11 to 17. FIG. 11 is a flowchart showing a process executed by the individual attribute/travel history/travel schedule inputting unit 20 and the individual learning menu creating unit 25, which are shown in FIG. 3. Once the process is started in this figure, it is first determined in step S1 whether or not a registration is the initial one to the system. If the registration is the initial one, individual attributes are registered in step S2. In step S3, an ID and a password are issued to the person who schedules a travel, and stored in the individual attribute database 22. Then, the flow goes to a process in step S6.

Or, if the registration is not the initial one in step S1, the ID and the password are input in step S4. Then, in step S5, it is determined whether or not the ID and the password are legal. If the ID and the password are not legal, the processes in and after step S4 are repeated. If the ID and the password are legal, the flow goes to the process in step S6.

In step S6, a registration of a travel history to the travel history database 23, for example, an entry for the traveler is created. In step S7, a registration of the travel schedule to the travel schedule database 24 is made. In step S8, an individual learning menu is created. In the process for creating an individual learning menu, contents of the individual attribute database 22, the travel history database 23, the travel schedule database 24, the learning history database 26, and the learning contents database 27 are referenced on demand, and the individual learning menu database 28 is created. Here, the process is terminated.

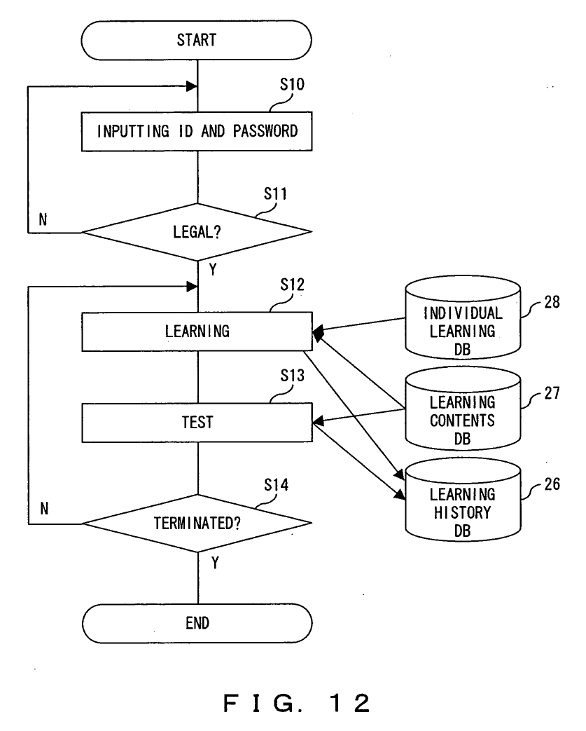

FIG. 12 is a flowchart showing a process executed by the preliminary learning unit 30. Once the process is started in this figure, an ID and a password are first input in step S10. In step S11, it is determined whether or not the ID and the password are legal. If the ID and the password are not legal, the processes in and after step S10 are repeated. If the ID and the password are legal, the flow goes to a process in step S12.

In step S12, the person who schedules the travel is made to conduct learning with the contents of the individual learning menu database 28 and the learning contents database 27. In step S13, a test is conducted in correspondence with the contents of the learning contents database 27. Its results are stored in the learning history database 26. In step S14, it is determined whether or not the learning with the individual learning menu is terminated. If the learning is not terminated yet, the processes in and after step S12 are repeated. When the learning is determined to be terminated, the process for the preliminary learning is completed.

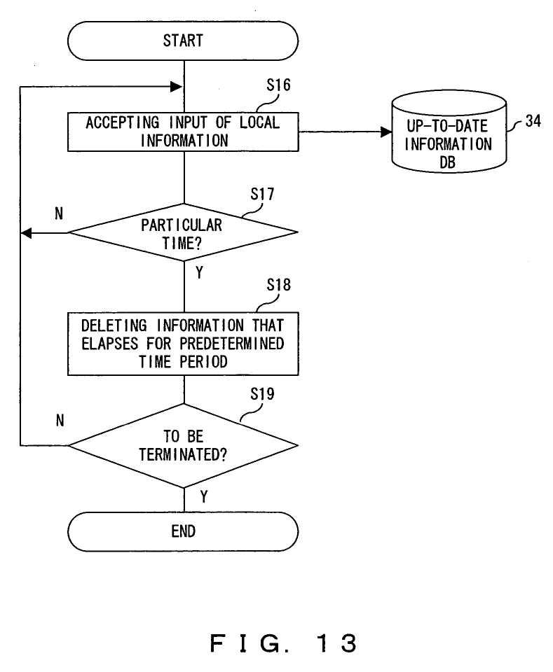

FIG. 13 is a flowchart showing a process executed by the up-to-date information collecting unit 33. Once the process is started in this figure, a process for accepting the input of local information is executed, and the input information is stored in the up-to-date information database 34 in step S16. In step S17, it is determined whether or not a particular time, for example, 12:00 a.m. at midnight is reached. If the particular time is not reached, the processes in and after step S16 are repeated. If the particular time is reached, information that elapses for a predetermined time period is deleted from the up-to-date information database 34 in step S18. This deletion is made to prevent old information from being held in the up-to-date information database 34. Then, in step S19, it is determined whether or not the process for collecting up-to-date information is to be terminated. If the up-to-date information collection process is not to be terminated, the processes in and after step S16 are repeated. The process for collecting up-to-date information is completed at a time point when the process is to be terminated.

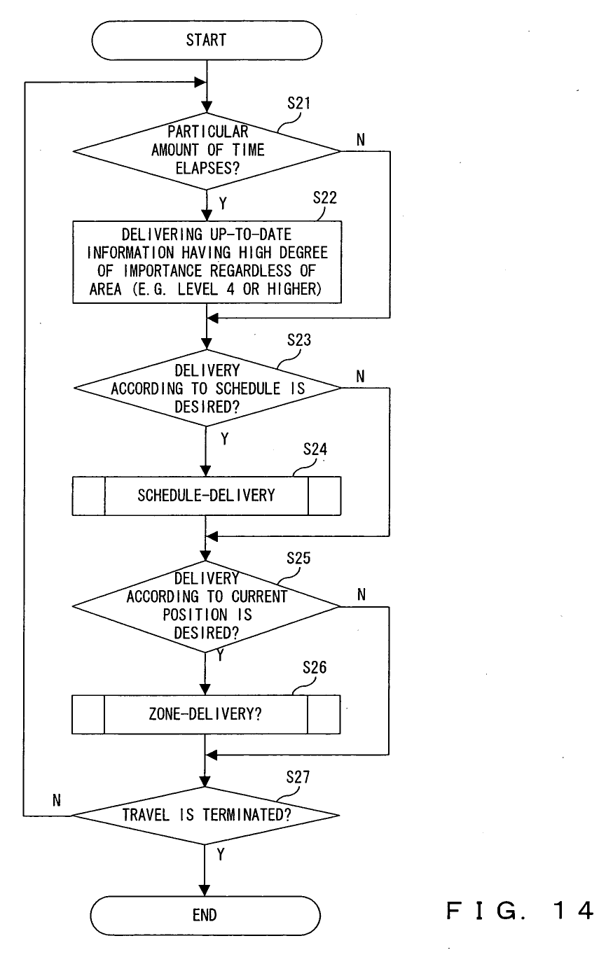

FIG. 14 is a flowchart showing a process for delivering safety-related information to a travel destination, which is executed by the local delivering unit 35. Once the process is started in this figure, it is first determined in step S21 whether or not a particular amount of time elapses. If the particular amount of time elapses, up-to-date information having a high degree of importance is delivered regardless of the location where a traveler or a person who stays overseas is currently staying in step S22. Here, as the up-to-date information having the high degree of importance, information whose level of the degree of importance is 4 or higher described with reference to FIG. 10 is delivered, for example, regardless of the travel destination, etc. of the traveler. The particular time in step S21 is set, for example, to every hour, and up-to-date information having a high degree of importance is delivered every hour. If the particular amount of time does not elapse, the flow goes to a process in step S23.

In step S23, it is determined whether or not the traveler desires the delivery of safety-related information according to his or her schedule. If the traveler desires the delivery according to his or her schedule, the schedule-delivery is made in step S24. If the traveler does not desire the schedule-delivery, the flow immediately goes to a process in step S25.

In step S25, it is determined whether or not the traveler desires the delivery according to the current location. If the traveler desires the delivery according to the current location, the zone-delivery is made in step S26. If the traveler does not desire the zone-delivery, the flow goes to a process in step S27. In step S27, it is determined whether or not the travel is terminated. If the travel is not terminated yet, the processes in and after step S21 are repeated, for example, every hour. The process for delivering up-to-date information is completed at a time point when the travel is terminated.

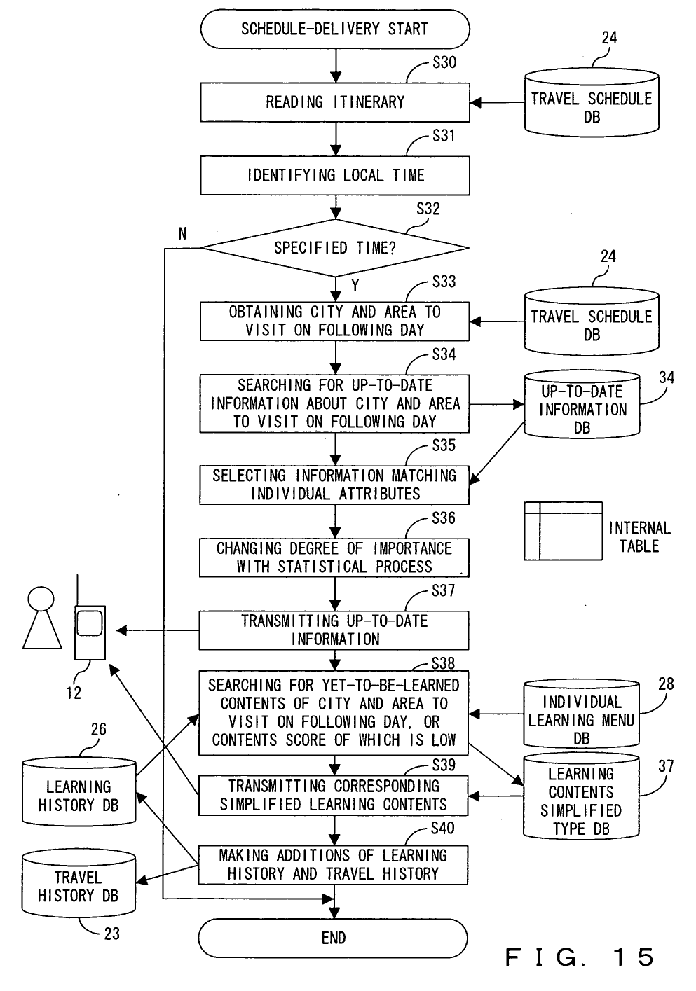

FIG. 15 is a flowchart showing the details of the process for the schedule-delivery, which is executed in step S24 of FIG. 14. Once the process is started in this figure, the itinerary of a traveler is first read from the travel schedule database 24 in step S30. In step S31, the local time is identified. In step S32, it is determined whether or not the local time is, for example, a time specified by a user.

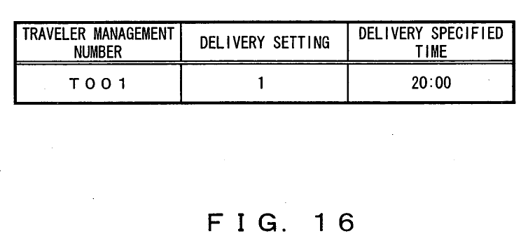

FIG. 16 exemplifies contents stored in a delivery setting table for determining whether or not the local time is the specified time. In this figure, a delivery setting method and a delivery specified time in the case of the schedule-delivery are stored in correspondence with the management number of a traveler. As the delivery setting method, any of 0 indicating that the delivery is unnecessary, 1 indicating the schedule-delivery, 2 indicating the zone-delivery, and 3 indicating both of the schedule-delivery and the zone-delivery is specified. As the delivery specified time, a delivery time in the case of the schedule-delivery is specified on a local time basis. A person who schedules a travel specifies the delivery setting method when reporting his or her travel schedule, etc., and also specifies a desired time of the schedule-delivery as the delivery specified time if the person desires the schedule-delivery. In this preferred embodiment, safety-related information, namely, up-to-date information is transmitted in correspondence with an area which a traveler is to visit on the following day as will be described later. Therefore, byway of example, a time after dinner, at which the traveler can easily receive the up-to-date information, or the like is specified as the time to receive the up-to-date information.

Turning back to step S32 of FIG. 15. The process is immediately terminated if the local time is not the specified time. If the local time is the specified time, a city and an area, which the traveler will visit on the following day according to the schedule, are obtained from the travel schedule database 24 in step S33. In step S34, up-to-date information about the city and the area, which the traveler will visit on the following day, are searched in the up-to-date information database 34. In step S35, information matching the individual attributes among the up-to-date information, namely, the up-to-date information whose trouble attribute match the individual attributes, which is described in the up-to-date information database shown in FIG. 10, is selected. In step S36, the degree of importance is changed with a statistical process on demand. In the selection of the up-to-date information in step S35, information that is not included in the preliminary learning can be selected, or information can be also selected according to a travel purpose. For example, if the purpose is scuba diving, information about a diving accident or about sharks becomes important.

In step S36, the degree of importance assigned to up-to-date information, namely, an up-to-date case, which is described with reference to FIG. 10, is changed based on the statistical tendency of an occurrence of an accident or a crime in the city or the area, which the traveler will visit on the following day. Even for an up-to-date case having a relatively low degree of importance, such as pickpocketing, a process for raising the degree of importance is executed if the trouble has frequently occurred in recent days in the city or the area. This process for changing the degree of importance is executed by using an internal table for working in correspondence with the traveler without changing the contents of the up-to-date information database 34. The up-to-date information selected in step S37 is transmitted to the traveler terminal 12 in correspondence with a change result of the degree of importance. Here, the up-to-date information can be also transmitted, for example, in a form where the information is arranged in descending order of the degree of importance so as to enable the traveler to recognize the degree of importance.

Then, in step S38, contents of learning yet to be conducted for the city and the area, which the traveler will visit on the following day, and contents of learning the test score of which is low are searched in the learning history database 26 and the individual learning menu database 28. In step S39, corresponding simplified learning contents within the learning contents simplified type database 37 is transmitted according to a search result. In step S40, additions of the learning history and the travel history are made to the learning history database 26 and the travel history database 23, and the process is completed. As described above, in this preferred embodiment, a traveler can conduct not only preliminary learning but also learning at a travel destination on demand. Especially, the traveler can learn about an accident or a crime, which has occurred very recently, even during a travel.

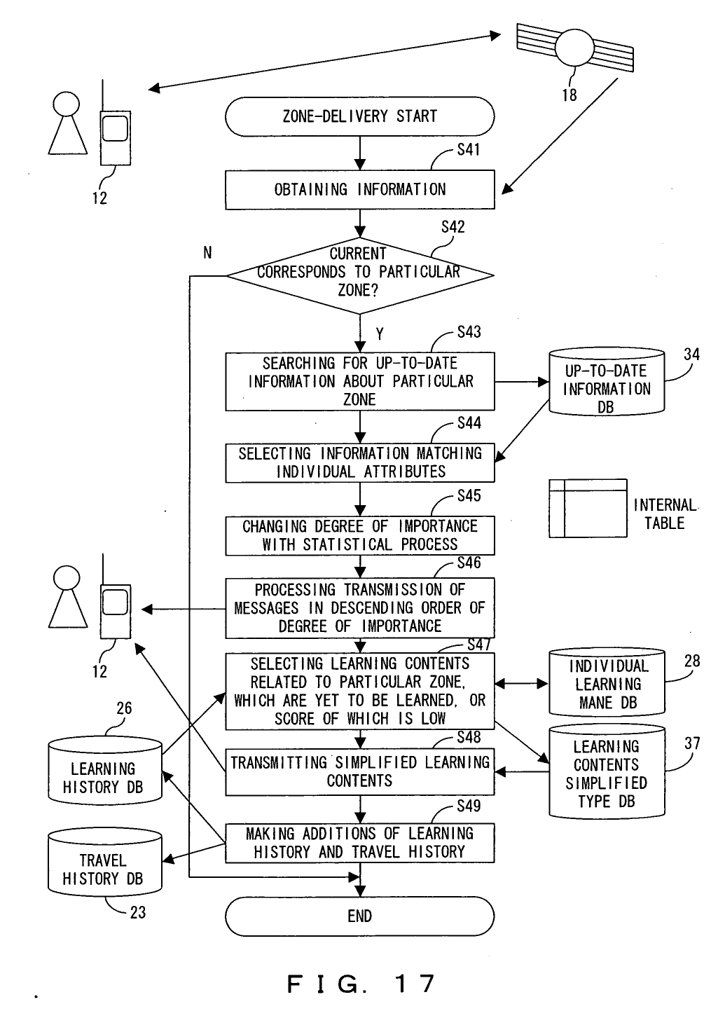

FIG. 17 is a flowchart showing the details of the process for the zone-delivery, which is executed in step S26 of FIG. 14. The process in this figure is similar to that for the schedule-delivery in FIG. 15. Therefore, the description is provided by mainly referring to different processes. Once the process is started, the location information of a traveler is obtained in step S41. In this process, the location of the traveler terminal 12 is detected by a GPS satellite 18.

Then, it is determined in step S42 whether or not the current location of the traveler corresponds to a particular zone. If the current location does not correspond to the particular zone, the process is terminated without delivering up-to-date information. Here, the particular zone indicates a city and/or an area, in which, for example, the occurrence frequency of an accident or a crime is high, and on which a traveler must pay special attention. If the current location of a traveler corresponds to the particular zone, this means that the traveler already enters the particular zone, or stays in a city, etc. adjacent to the particular zone and can possibly enter the particular zone, for example, on the following day. Whether or not the traveler will enter the particular zone on the following day is unknown to the traveler learning assisting center 10 shown in FIG. 2. However, up-to-date information corresponding to the particular zone is delivered in order to alert the traveler.

Namely, in step S43, up-to-date information about the particular zone is searched in the up-to-date information database 34. In steps S44 and S45, up-to-date information matching individual attributes is selected, and the degree of importance is changed with a statistical process in a similar manner as in FIG. 15. In step S46, the transmission of the up-to-date information to the traveler terminal 12 is processed as messages in descending order of the degree of importance. Then, in steps S47 to S49, simplified learning contents related to the particular zone are transmitted, and additions of the learning history and the travel history are made in a similar manner as in FIG. 15. Here, the process is completed.

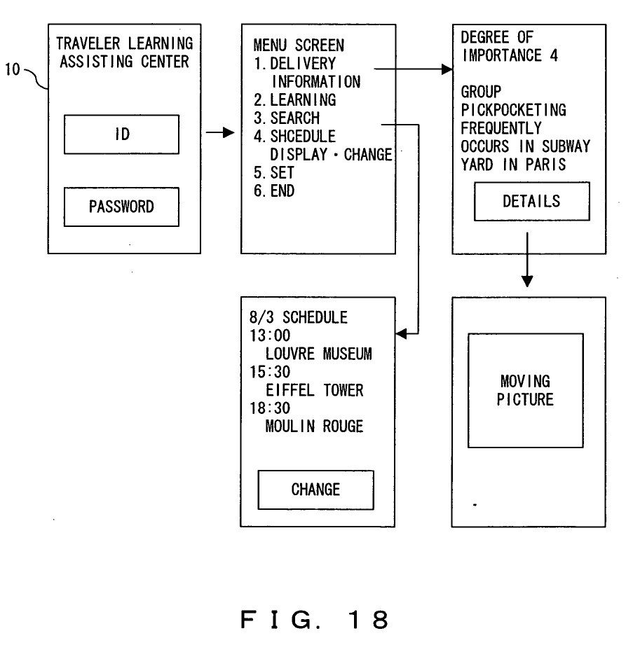

FIG. 18 explains a display screen transition made on the side of the traveler terminal 12 shown in FIG. 2. The traveler can browse up-to-date information with his or her terminal 12 before information is delivered, can display detailed information or related information, or can input a schedule change.

In FIG. 18, the ID and the password of the traveler are stored in the traveler learning assisting center 10. The traveler can perform various types of operations on a menu screen with the ID and the password. With the click of “1. DELIVERY INFORMATION”, delivery information, namely, up-to-date information from the center can be displayed as shown on the right side. The degree of importance is displayed in the up-to-date information, normally, in a text format. Here, with the click of the “DETAILS” button, the up-to-date information is displayed in detail, for example, by using a moving picture, without being limited to the text format. Actually, since a considerable amount of time is required to display the moving picture, the moving picture display is made only if the traveler requests detailed information.

With the click of “2. LEARNING”, learning for the up-to-date information can be continued at a desired time. With the click of “3. SEARCH”, up-to-date information about a city and an area can be searched by specifying, for example, the city and the area, without waiting for the delivery of the up-to-date information from the center side.

With the click of “4. SCHEDULE DISPLAY/CHANGE”, for example, a schedule of the following day is displayed, and a schedule change input can be made with the click of the “CHANGE” button. This schedule change input is received by the travel schedule changing unit 40 shown in FIG. 3, and provided to the local delivering unit 35. Then, the schedule change is reflected on the delivery of the subsequent up-to-date information. With the click of “5. SET”, a delivery method can be changed or set as described with reference to FIG. 16. Namely, settings such as the schedule-delivery, the zone-delivery, both the schedule-delivery and the zone-delivery, and the like can be made. With the click of “6. END”, this application is terminated.

The above description explains the preferred embodiment according to the present invention by mainly referring to the processes for making a person who schedules an overseas travel conduct preliminary learning when the person subscribes an overseas travel accident insurance, and for delivering up-to-date information as safety-related information about an accident or a crime to the traveler as part of an overseas travel accident insurance service at a travel destination. However, a scope to which the present invention is applied is not limited to such a field. The present invention may be applied, for example, to a domestic traveler, or can be applied as a service not only for a traveler but also for a person who makes an overseas business trip, a person who stays overseas, etc. as a matter of course.

Furthermore, although a discount of an overseas travel accident insurance is not particularly referred to in the preferred embodiment, it can be implemented in correspondence with a reduction in an insurance payment. This is because it is expected that the risk of a traveler, etc. is reduced by preliminary learning, and also an insurance payment is decreased.

The present invention can be applied to every industry that is advantageous in improving the safety of a traveler or a person who stays overseas by delivering safety-related information, to say nothing of an industry of an insurance such as an overseas travel accident insurance, etc. Therefore, by way of example, a travel agent can apply the present invention as a service rendered for a customer for whom the agent itself arranges a travel, a credit card company can apply the present invention as a service rendered for a card member, or a general enterprise can apply the present invention as a service rendered for an employee who makes an overseas business trip.

1. A safety-related information delivering method with which a computer delivers safety-related information to a person who desires delivery of the safety-related information, comprising:
determining whether the person who desires the delivery desires either schedule-delivery which is delivery of safety-related information according to his or her schedule or zone-delivery which is delivery of safety-related information corresponding to a current location of the person according to contents stored in a memory; and
delivering the safety-related information to the person in correspondence with a determination result via a network.

2. The safety-related information delivering method according to claim 1, further comprising:
externally receiving up-to-date information as the safety-related information, assigning a degree of importance to the up-to-date information, and storing the information in a memory; and
selecting up-to-date information stored in the memory, and delivering the selected information, when delivering the safety-related information.

3. The safety-related information delivering method according to claim 2, further comprising
changing the degree of importance, which is assigned to the up-to-date information stored in the memory, in correspondence with a condition including the current location of the person who desires the delivery, and delivering the up-to-date information to which a high degree of importance after being changed is assigned, when delivering the safety-related information.

4. The safety-related information delivering method according to claim 2, further comprising
selecting the up-to-date information in correspondence with individual attributes and a history of staying at location of the person who desires the delivery, and delivering the selected information, when delivering the safety-related information.

5. The safety-related information delivering method according to claim 1, further comprising
making the person who desires the delivery conduct preliminary learning for improving safety, and storing a learning history corresponding to a result of the learning in a memory.

6. The safety-related information delivering method according to claim 5, further comprising:
creating an individual learning course for the preliminary learning in correspondence with the individual attributes, the history of staying at location, the schedule, and the learning history of the person who desires the delivery; and
making the person conduct the preliminary learning with the individual learning course.

7. The safety-related information delivering method according to claim 5, further comprising
delivering to the person who desires the delivery new learning contents corresponding to the current location of the person who desires the delivery in correspondence with the learning history stored in the memory, when delivering the safety-related information.

8. The safety-related information delivering method according to claim 1, further comprising
accepting a schedule change from a person who desires the schedule-delivery of the safety-related information, and reflecting contents of the change when delivering the safety-related information.

9. The safety-related information delivering method according to claim 1, further comprising
delivering important safety information at a preset time regardless of whether the person who desires the delivery desires either the schedule-delivery or the zone-delivery.

10. The safety-related information delivering method according to claim 9, further comprising:
externally receiving up-to-date information as the safety-related information, assigning a degree of importance to the up-to-date information, and storing the information in a memory; and
selecting up-to-date information stored in the memory, and delivering the selected information, when delivering the safety-related information to which the degree of importance is assigned.

11. An apparatus for delivering safety-related information to a person who desires delivery of the safety-related information, comprising:
a delivery method determining unit determining whether the person who desires the delivery desires either schedule-delivery which is delivery of safety-related information according to his or her schedule or zone-delivery which is delivery of safety-related information corresponding to a current location of the person; and
a safety-related information delivering unit delivering the safety-related information to the person in correspondence with a determination result.

12. A system for delivering safety-related information to a person who desires delivery of the safety-related information, comprising:
a safety-related information delivering apparatus comprising a delivery method determining unit determining whether the person who desires the delivery desires either schedule-delivery which is delivery of safety-related information according to his or her schedule or zone-delivery which is delivery of safety-related information corresponding to a current location of the person, and a safety-related information delivering unit delivering the safety-related information to the person in correspondence with a determination result; and
a terminal device comprising a display unit, which is connected to said safety-related information delivering apparatus via a network, displaying the safety-related information delivered from said safety-related information delivering apparatus.

13. A storage medium on which is recorded a program for causing a computer to deliver safety-related information to a person who desires delivery of the safety-related information, the program enabling the computer to function as:
a delivery method determining unit determining whether the person who desires the delivery desires either schedule-delivery which is delivery of safety-related information according to his or her schedule or zone-delivery which is delivery of safety-related information corresponding to a current location of the person; and
a safety-related information delivering unit delivering the safety-related information to the person in correspondence with a determination result.

14. An apparatus for delivering safety-related information to a person who desires delivery of the safety-related information, comprising:
delivery method determining means for determining whether the person who desires the delivery desires either schedule-delivery which is delivery of safety-related information according to his or her schedule or zone-delivery which is delivery of safety-related information corresponding to a current location of the person; and
safety-related information delivering means for delivering the safety-related information to the person in correspondence with a determination result.
